(19) United States
(12) Patent Application Publication
(10) Pub. No.: US 2014/0002802 A1
(43) Pub. Date: Jan. 2, 2014

(54) PROJECTION APPARATUS AND PROJECTION LENS THEREOF

(71) Applicants: YA-LING HSU, Hsinchu (TW); Yi-Hsueh Chen, Hsinchu (TW); Hsin-Hung Lin, Hsinchu (TW); Ching-Lun Lin, Hsinchu (TW); Chao-Shun Chen, Hsinchu (TW)

(72) Inventors: YA-LING HSU, Hsinchu (TW); Yi-Hsueh Chen, Hsinchu (TW); Hsin-Hung Lin, Hsinchu (TW); Ching-Lun Lin, Hsinchu (TW); Chao-Shun Chen, Hsinchu (TW)

(73) Assignee: Young Optics Inc., Hsinchu (TW)

(21) Appl. No.: 13/534,470

(22) Filed: Jun. 27, 2012

(51) Int. Cl. G03B 21/28; G02B 17/08

(52) U.S. Cl. 353/69; 359/364

(57) ABSTRACT

A projection lens includes a first image system, a second image system, and a concave reflector arranged in order. The first image system and the second image system define an optical axis, and the concave reflector is disposed at a first side of the optical axis. A projection apparatus using the projection lens is also provided, wherein the first image system is disposed between a light valve of the projection apparatus and the second image system, and the light valve is disposed at the first side of the optical axis.

### FIELD OF THE INVENTION

The invention relates to a display apparatus, and more particularly to a projection apparatus and a projection lens thereof.

### BACKGROUND OF THE INVENTION

The projection apparatus is used to form an image on a screen. There must be enough distance between the projection apparatus and the screen to achieve a proper image size. Recently, to achieve the proper image size and reduce the distance between the projection apparatus and the screen, the wide angle projection lens is applied to the projection apparatus. However, the wide angle projection lens may result in image aberration such as distortion, field curvature or astigmatism.

U.S. Pat. No. 7,567,380, U.S. Pat. No. 7,717,573, U.S. Pat. No. 8,054,541, U.S. Pat. No. 7,009,765, U.S. Pat. No. 6,896,375, U.S. Pat. No. 7,150,537, U.S. Pat. No. 7,341,353, U.S. Pat. No. 7,545,586, U.S. Pat. No. 6,631,994, U.S. Pat. No. 4,427,274, U.S. Pat. No. 5,495,306, U.S. Pat. No. 5,477,394, U.S. Pat. No. 6,994,442, U.S. Pat. No. 7,871,166, and US Publications No. 2010/0172022, No. 2010/0231873 disclose various projection lenses to solve the above-mentioned problem. However, in the conventional projection lenses, the size of the lens or the reflector nearest the image side is too large, and thus the conventional projection lenses are hardly used in the pocket-portable electronic device with a projection function.

### SUMMARY OF THE INVENTION

The invention provides a projection apparatus with a compact size.

The invention further provides a projection lens with a compact size, short focal length, and wide angle.

An embodiment of the invention provides a projection apparatus including a light source, a light valve, and a projection lens. The light source is configured to provide an illumination beam. The light valve is disposed on a transmission path of the illumination beam and adapted to convert the illumination beam into an image beam, and the projection lens is disposed on a transmission path of the image beam. The projection lens includes a first image system, a second image system, and a concave reflector arranged in order. The first image system is disposed between the light valve and the second image system, the first image system and the second image system define an optical axis, and the light valve and the concave reflector are disposed at a first side of the optical axis.

Another embodiment of the invention provides a projection lens adapted to a projection apparatus. The projection lens includes a first image system, a second image system, and a concave reflector arranged in order. The first image system is disposed between a light valve of the projection apparatus and the second image system. The first image system and the second image system define an optical axis, and the light valve and the concave reflector are disposed at a first side of the optical axis.

In embodiments of the invention, the projection lens includes the first image system, the second image system, and the concave reflector arranged in order, and the light valve and the concave reflector are located at the same side of the optical axis defined by the first image system and the second image system. Therefore, the projection lens may achieve a compact size, and the projection apparatus using the projection lens also may achieve a compact size.

### BRIEF DESCRIPTION OF THE DRAWINGS

The invention will become more readily apparent to those ordinarily skilled in the art after reviewing the following detailed description and accompanying drawings, in which:

FIG. 1 is a schematic block diagram showing a projection apparatus according to an embodiment of the invention;

FIG. 2A is a schematic view of a light valve and a projection lens of FIG. 1;

FIG. 2B is showing the first intermediate image having pincushion-like distortion;

FIG. 2C is showing the first intermediate image having barrel-like distortion; and

FIG. 3 is a schematic view showing a relative position between an image on a screen and the projection lens of FIG. 2A.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

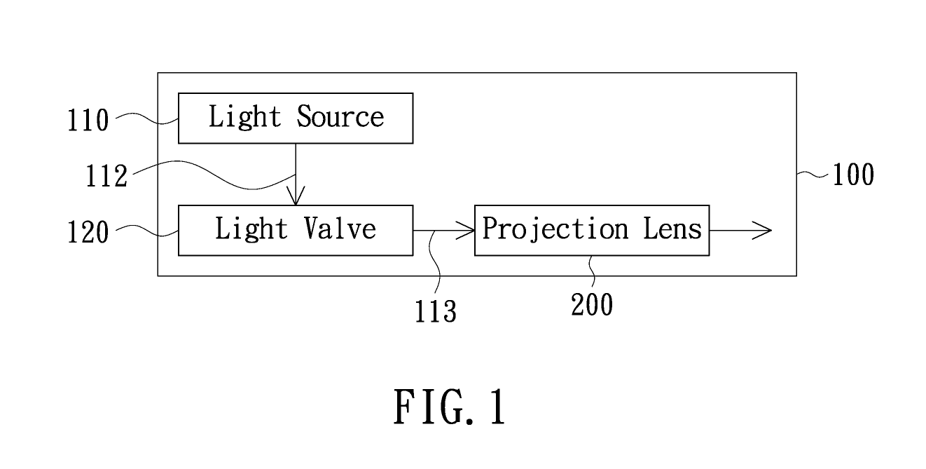

FIG. 1 is a schematic block diagram showing a projection apparatus according to an embodiment of the invention. Referring to FIG. 1, the projection apparatus 100 of the embodiment includes a light source 110, a light valve 120 and a projection lens 200. The light source 110 is configured to provide an illumination beam 112, and the light valve 120 is disposed on a transmission path of the illumination beam 112 and adapted to convert the illumination beam 112 into an image beam 113. The light valve 120 may be a transmissive light valve (e.g. a transmissive liquid crystal display panel) or a reflective light valve (e.g. a digital micro-lens device or a liquid crystal on silicon panel). The projection lens 200 is disposed on a transmission path of the image beam 113 and adapted to project the image beam 113 onto a screen (not shown), so as to form an image on the screen.

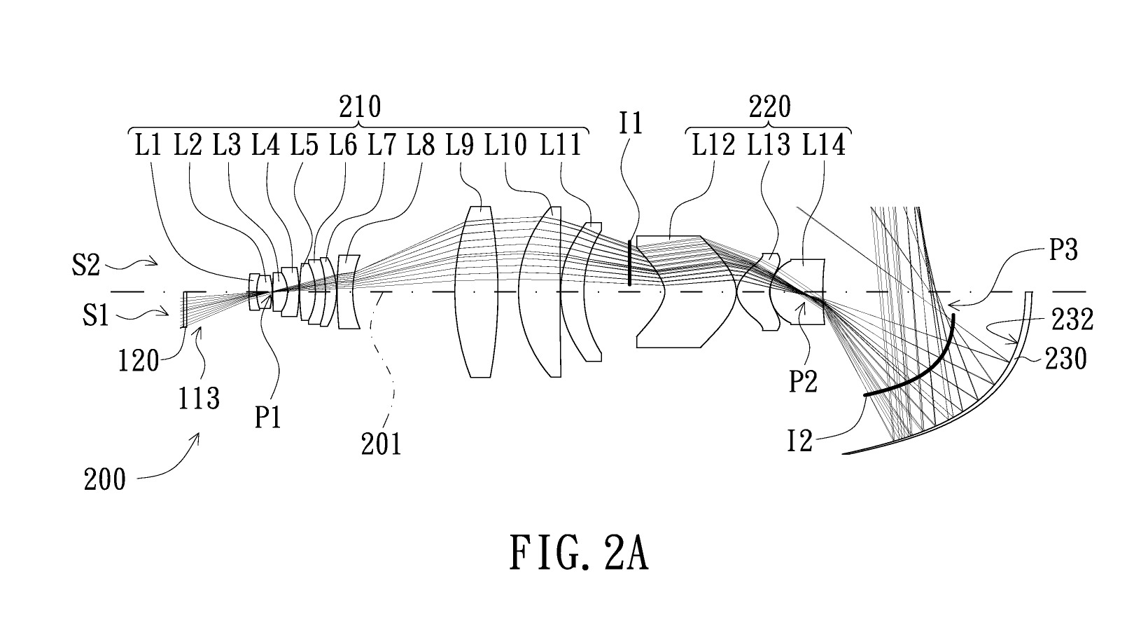

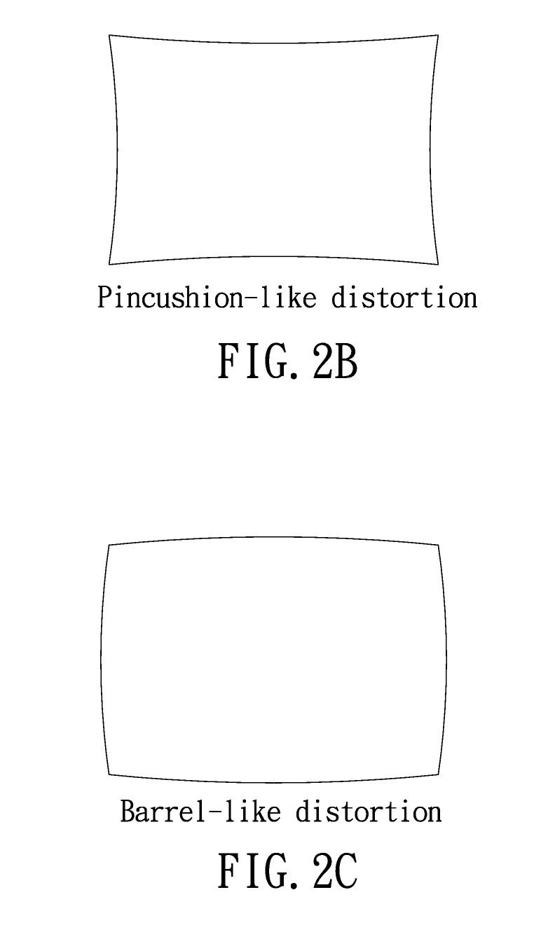

Referring to FIG. 2A, the projection lens 200 includes a first image system 210, a second image system 220, and a concave reflector 230 arranged in order, wherein the first image system 210 is disposed between the light valve 120 and the second image system 220. The first image system 210 and the second image system 220 define an optical axis 201. The light valve 120 and the concave reflector 230 are disposed at the first side S1 of the optical axis 201.

The image beam 113 from the light valve 120 is formed as a first intermediate image I1 between the first image system 210 and the second image system 220 by the first image system 210. The first intermediate image I1 is formed at a second side S2 of the optical axis 201, wherein the first side S1 is opposite to the second side S2. The first intermediate image I1 may have obvious distortion (greater than 1.5%) such as pincushion-like distortion shown in FIG. 2B or barrel-like distortion shown in FIG. 2C, or have slight distortion (smaller than 1.5%).

Referring to FIG. 2A, the image beam 113 from the first intermediate image I1 is formed as a second intermediate image 12 between the second image system 220 and the concave reflector 230 by the second image system 220. The second intermediate image 12 is, for example, a curved image and formed at the first side S1. That is, the first intermediate image I1 and the second intermediate image 12 are formed at two opposite sides of the optical axis 201. The image beam 113 from the second intermediate image 12 is reflected to the screen by the concave reflector 230, so as to form the image on the screen. When the first intermediate image I1 has the obvious distortion, the second image system 220 and the concave reflector 230 may used to eliminate the obvious distortion of the first intermediate image I1, so as to form the image with slight distortion or without distortion on the screen. Further, the relative position between the second image system 220 and the first image system 210 or between the second image system 220 and the concave reflector 230 may be adjusted to precisely focus the image on the screen for compensating a mechanical tolerance of the projection apparatus 100.

In the embodiment, the first image system 210 includes a plurality of lenses, and the lenses may include at least one aspherical lens and at least one spherical lens. More specifically, the lenses include, for example, a lens L1, a lens L2, a lens L3, a lens L4, a lens L5, a lens L6, a lens L7, a lens L8, a lens L9, a lens L10, and a lens L11 arranged in order, wherein the lens L1 is located between the light valve 120 and the lens L2. The lens L1 nearest the light valve 120 and the lens L11 nearest the second image system 220 may be respectively an aspherical lens, and the other lenses L2, L3, L4, L5, L6, L7, L8, L9, L10 of the first image system 210 may be respectively a spherical lens. Moreover, a pupil P1 of the first image system 210 is, for example, located between the lens L2 and the lens L3.

The second image system 220 includes a plurality of lenses, and the lenses may include at least one aspherical lens and at least one spherical lens. More specifically, the lenses include, for example, a lens L12, a lens L13, and a lens L14 arranged in order, wherein the lens L12 is located between the first image system 210 and the lens L13. The lens L12 nearest the first image system 210 may be an aspherical lens, the lens L14 nearest the concave reflector 230 may be a spherical lens, and the lens L13 between the lens 12 and the lens 14 may be an aspherical lens. Furthermore, a pupil P2 of the second image system 220 is, for example, located at an end of the second image system 220 near the concave reflector 230. More specifically, the pupil P2 of the second image system 220 is, for example, located in the lens L14. Since the pupil P2 is located at the end of the second image system 220 near the concave reflector 230, the size of the lens L14 nearest the concave reflector 230 may be efficiently reduced, and thus, the size of the projection lens 200 is reduced.

The concave reflector 230 may have an aspherical reflective surface 232 adapted to reflect the image beam 113 to the screen. A pupil P3 is generated after the image beam 113 is reflected by the concave reflector 230. The aspherical reflective surface 232 may eliminate coma, astigmatism, distortion or other aberration, and the first image system 210 and the second image system 220 may also eliminate the aberration. In an embodiment that the first intermediate image I1 further has tangential field curvature, the second image 220 and the concave reflector 230 may be used to correct the tangential field curvature. The aspherical reflective surface 232 may reduce the focal length of the projection lens 200, and thus, the projection lens 200 may achieve a wide angle projection lens. Moreover, since the transmission path of the image beam 113 is turned by the concave reflector 230, the length of the projection lens 200 may be reduced.

In the embodiment, the projection lens 200 may have a compact size and a short focal length due to the above-mentioned reasons, so the projection apparatus 100 may achieve a compact size. Therefore, the projection apparatus 100 may be, but not limited to, broadly used in the pocket-portable electronic device.

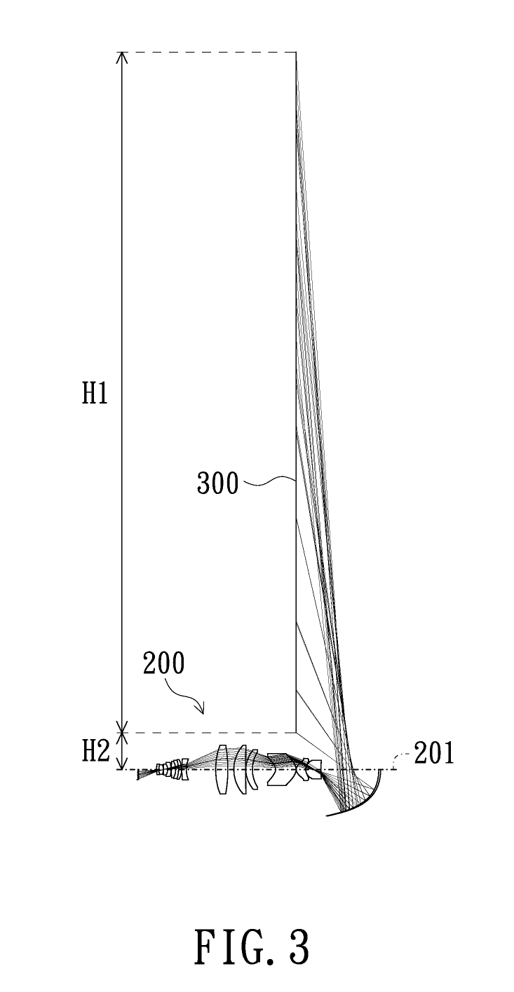

Referring to FIGS. 2A and 3, the relative position of the image on the screen 300 and the projection lens 200 satisfies an inequality of (H1+H2)/H1>100%, wherein H1 is the height of the image on the screen, and H2 is the distance between the image and the optical axis 201. In the conventional projection lens, (H1+H2)/H1 is usually greater than 115% to prevent the interference between the lens of the conventional projection lens and the reflected image beam. However, in the embodiment, the size of the lens L14 nearest the concave reflector 230 may be efficiently reduced due to the pupil P2 being located at the end of the second image system 220 near the concave reflector 230, and thus, in the embodiment, (H1+H2)/H1 may be smaller than 115%. Moreover, in the embodiment, the proportion of the projection distance (from the projection lens 200 to the screen 300) to a horizontal width of the screen 300 is, for example, smaller than 0.45.

In summary, embodiments of the projection system have at least one of the following advantages. In embodiments of the invention, the projection lens includes the first image system, the second image system, and the concave reflector arranged in order, and the light valve and the concave reflector are located at the same side of the optical axis defined by the first image system and the second image system. For example, the first image system and the second image system defined the optical axis means that the two image systems have the same optical axis. Therefore, the projection lens may achieve a compact size, and the projection apparatus using the projection lens also may achieve a compact size. In embodiments of the invention, the second image system and the concave reflector may used to eliminate the obvious distortion of the first intermediate image, so as to form the image with slight distortion or without distortion on the screen. In embodiments of the invention, the projection lens may have a short focal length and wide angle.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical invention, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A projection apparatus, comprising:
a light source configured to provide an illumination beam;
a light valve disposed on a transmission path of the illumination beam and adapted to convert the illumination beam into an image beam; and
a projection lens disposed on a transmission path of the image beam, the projection lens comprising a first image system, a second image system, and a concave reflector arranged in order, the first image system being disposed between the light valve and the second image system, the first image system and the second image system defining an optical axis, the light valve and the concave reflector being disposed at a first side of the optical axis.

2. The projection apparatus according to claim 1, wherein the image beam from the light valve is formed as a first intermediate image between the first image system and the second image system by the first image system, the image beam from the first intermediate image is formed as a second intermediate image between the second image system and the concave reflector by the second image system, the first intermediate image is formed at a second side of the optical axis opposite to the first side of the optical axis, the second intermediate image is formed at the first side of the optical axis, and the image beam from the second intermediate image is reflected by the concave reflector.

3. The projection apparatus according to claim 1, wherein the first image system comprises a plurality of lenses, and the lenses comprise at least one aspherical lens and at least one spherical lens.

4. The projection apparatus according to claim 3, wherein a lens of the lenses of the first image system nearest the light valve and a lens of the lenses of the first image system nearest the second image system are aspherical lenses.

5. The projection apparatus according to claim 1, wherein the second image system comprises a plurality of lenses, and the lenses comprise at least one aspherical lens and at least one spherical lens.

6. The projection apparatus according to claim 5, wherein a lens of the lenses of the second image system nearest the first image system is an aspherical lens and a lens of the lenses of the second image system nearest the concave reflector is a spherical lens.

7. The projection apparatus according to claim 1, wherein the concave reflector has an aspherical reflective surface.

8. The projection apparatus according to claim 1, wherein a pupil of the second image system is located at an end of the second image system near the concave reflector.

9. A projection lens, adapted to a projection apparatus, the projection lens comprising a first image system, a second image system, and a concave reflector arranged in order, the first image system being disposed between a light valve of the projection apparatus and the second image system, the first image system and the second image system defining an optical axis, the light valve and the concave reflector being disposed at a first side of the optical axis.

10. The projection lens according to claim 9, wherein the image beam from the light valve is formed as a first intermediate image between the first image system and the second image system by the first image system, the image beam from the first intermediate image is formed as a second intermediate image between the second image system and the concave reflector by the second image system, the first intermediate image is formed at a second side of the optical axis opposite to the first side of the optical axis, the second intermediate image is formed at the first side of the optical axis, and the image beam from the second intermediate image is reflected by the concave reflector to project onto a screen.

11. The projection lens according to claim 9, wherein the first image system comprises a plurality of lenses, and the lenses comprise at least one aspherical lens and at least one spherical lens.

12. The projection lens according to claim 11, wherein a lens of the lenses of the first image system nearest the light valve and a lens of the lenses of the first image system nearest the second image system are aspherical lenses.

13. The projection lens according to claim 9, wherein the second image system comprises a plurality of lenses, and the lenses comprise at least one aspherical lens and at least one spherical lens.

14. The projection lens according to claim 13, wherein a lens of the lenses of the second image system nearest the first image system is an aspherical lens and a lens of the lenses of the second image system nearest the concave reflector is a spherical lens.

15. The projection lens according to claim 9, wherein the concave reflector has an aspherical reflective surface.

16. The projection lens according to claim 9, wherein a pupil of the second image system is located at an end of the second image system near the concave reflector.
